(19) United States
(12) Patent Application Publication
(10) Pub. No.: US 2020/0134955 A1
(43) Pub. Date: Apr. 30, 2020

(54) VEHICLE OPERATION SYSTEM, IN-VEHICLE DEVICE, ELECTRONIC KEY, AND VEHICLE OPERATION METHOD

(71) Applicant: SUMITOMO ELECTRIC INDUSTRIES, LTD., Osaka-shi, Osaka (JP)

(72) Inventor: Yuri KISHITA, Osaka-shi, Osaka (JP)

(73) Assignee: SUMITOMO ELECTRIC INDUSTRIES, LTD., Osaka-shi, Osaka (JP)

(21) Appl. No.: 16/621,975

(22) PCT Filed: Jan. 23, 2018
(86) PCT No.: PCT/JP2018/001894

§ 371 Date: Dec. 12, 2019

(30) Foreign Application Priority Data
Jun. 14, 2017 (JP) 2017-0117210

(51) Int. Cl. G07C 9/28; B60R 25/04; B60R 25/24; G08G 1/01; G06Q 10/02; G08G 1/00

(52) U.S. Cl. CPC G07C 9/28; B60R 25/04; G08G 1/20; G08G 1/0116; G06Q 10/02; B60R 25/24

(57) ABSTRACT

A vehicle operation system includes a plurality of electronic keys and an in-board device that exchanges a signal with the plurality of electronic keys. The in-board device comprises a determining unit to determine, on the basis of the acquired key information from one electronic key, whether operation of a vehicle on which the in-board device is possible, and a transmitting unit to transmit operation information indicating the operation status when operation has been determined to be possible. The vehicle operation system further includes a communication device to receive the operation information transmitted by the transmitting unit of the in-board device either from the in-board device or via the electronic key. The communication device comprises a storage unit that stores the received operation information while associating same with vehicle identification information and with the key information or operator identification information for an operator.

### TECHNICAL FIELD

The present invention relates to a vehicle operation system, an in-vehicle device, an electronic key, and a vehicle operation method. Priority is claimed on Japanese Patent Application No. 2017-117210, filed Jun. 14, 2017, the content of which is incorporated herein by reference.

### BACKGROUND ART

Patent Document 1 discloses a system in which an operation management device transmits a destination through a communication device mounted on each transportation vehicle in correspondence with an instruction request from the transportation vehicle, and the destination is displayed on a display unit provided in the transportation vehicle in order for workers to view the destination.

### PRIOR ART DOCUMENT

### Patent Document

Patent Document 1: Japanese Patent Application Laid-Open Publication No. 2012-046309

### SUMMARY OF THE INVENTION

A vehicle operation system according to an aspect of the present disclosure, comprises: a plurality of electronic keys; and an in-vehicle device that transmits and receives a signal to and from the plurality of electronic keys. Each of the plurality of electronic keys stores key information, and includes an output unit that outputs the key information to the in-vehicle device. The in-vehicle device includes an acquiring unit that acquires key information from any one electronic key among the plurality of electronic keys, a determining unit that determines driving possibility of a vehicle on which the in-vehicle device is mounted on the basis of the acquired key information, and a transmitting unit that transmits driving information indicating a driving situation in correlation with the key information if driving is determined as possible by the determining unit. The vehicle operation system further comprises a communication device that receives the driving information transmitted by the transmitting unit of the in-vehicle device from the in-vehicle device or through the electronic key in a communication manner, and the communication device includes a storage unit that stores the received driving information in correlation with vehicle identification information of the vehicle on which the in-vehicle device is mounted, and the key information output from the electronic key or driver identification information of a driver specified from the key information.

An in-vehicle device according to an aspect of the present disclosure, comprises: an acquiring unit that acquires key information from any one electronic key among a plurality of electronic keys; a determining unit that determines driving possibility of a vehicle on which the in-vehicle device is mounted on the basis of the acquired key information; and a transmitting unit that transmits driving information indicating a driving situation in the vehicle in correlation with the key information if driving is determined as possible by the determining unit.

An electronic key according to an aspect of the present disclosure, comprises: a storage unit that stores key information; an output unit that outputs the key information to an in-vehicle device; a first communication unit that receives driving information indicating a driving situation in a vehicle on which the in-vehicle device is mounted, and vehicle identification information from the in-vehicle device if driving is determined as possible by the in-vehicle device on the basis of the output key information; and a second communication unit that transmits the driving information and the vehicle identification information which are received by the first communication unit, to a communication device, with the key information stored in the storage unit.

A vehicle operation method according to an aspect of the present disclosure, is performed in a system that comprises a plurality of electronic keys, and an in-vehicle device that transmits and receives a signal to and from the plurality of electronic keys. The vehicle operation method includes: storing key information by each of the plurality of electronic keys; outputting the key information to the in-vehicle device by the electronic key; acquiring key information output from any one electronic key among the plurality of electronic keys by the in-vehicle device; determining driving possibility of a vehicle on which the in-vehicle device is mounted on the basis of the acquired key information by the in-vehicle device; transmitting driving information indicating a driving situation in correlation with the key information by the in-vehicle device if driving is determined as possible; receiving the driving information transmitted by a transmitting unit of the in-vehicle device from the in-vehicle device or through the electronic key in a communication manner by a communication device that exists outside the vehicle; and storing the received driving information in a storage unit in correlation with vehicle identification information of the vehicle on which the in-vehicle device is mounted, and the key information output from the electronic key or driver identification information of a driver specified from the key information.

### BRIEF DESCRIPTION OF THE DRAWINGS

FIG. 1 is a view illustrating an overview of a vehicle operation system according to a first embodiment.

FIG. 2 is a block diagram illustrating a configuration of the vehicle operation system according to the first embodiment.

FIG. 3 is a block diagram illustrating a configuration of the vehicle operation system according to the first embodiment.

FIG. 4 is a flowchart illustrating an example of a procedure of information transmission from an in-vehicle device to a communication device according to the first embodiment.

FIG. 5 is a view illustrating an overview of a vehicle operation system according to a second embodiment.

FIG. 6 is a block diagram illustrating a configuration of the vehicle operation system according to the second embodiment.

FIG. 7 is a flowchart illustrating an example of a procedure of information transmission and reception between respective devices according to the second embodiment.

FIG. 8 is a flowchart illustrating an example of a procedure of information transmission and reception between respective devices according to the second embodiment.

FIG. 9 is a block diagram illustrating a configuration of a vehicle operation system according to a third embodiment.

FIG. 10 is a flowchart illustrating an example of a procedure of issuing key information in a server device.

FIG. 11 is a flowchart illustrating an example of a procedure of a determination on driving possibility of a vehicle and collection of driving information according to the third embodiment.

FIG. 12 is a flowchart illustrating an example of a procedure of a determination on driving possibility of a vehicle and collection of driving information according to the third embodiment.

### MODES FOR CARRYING OUT THE INVENTION

### Problems to be Solved by the Invention

In accordance with technical advancement in a sensor technology, and respective elements of industrial robots and the like in a field of factory automation (FA), a further increase in efficiency of production has progressed. Even in a factory in which respective processes are automated, in supply of parts, recovery and delivery of goods, transportation of products to a delivery center, loading of the products on a delivery vehicle, and the like, an industrial transportation vehicle such as a forklift that is driven by a worker is frequently used.

With regard to the transportation vehicle, in a work site that is allocated to a worker who drives the transportation vehicle, the worker determines objects to be carried and a method for carrying the objects. Accordingly, in a state in which a plurality of transportation vehicles exists, there is a possibility that accidence such as overlapping of transportation objects and collision may occur.

With regard to management of an industrial transportation vehicle such as a forklift, it is necessary to perform the comprehensive management on the basis of not only efficiency based on an instruction given from a management device but also a configuration in which data is collected and layout of vehicles and workers based on the data is performed also in consideration of prevention of accidence occurrence, prevention of theft of a transportation vehicle, and the like. It may be necessary to change the layout of the vehicle in real time on the basis of the collected data.

An object of the present disclosure is to provide a vehicle operation system, an in-vehicle device, an electronic key, and a vehicle operation method which are capable of realizing collection of an operation situation of a vehicle.

### Description of an Embodiment of the Present Invention

First, the contents of an embodiment of the present invention will be listed and described. Furthermore, at least portions of the embodiments described below may be combined arbitrarily.

A vehicle operation system according to an embodiment, comprises: a plurality of electronic keys; and an in-vehicle device that transmits and receives a signal to and from the plurality of electronic keys. Each of the plurality of electronic keys stores key information, and includes an output unit that outputs the key information to the in-vehicle device. The in-vehicle device includes an acquiring unit that acquires key information from any one electronic key among the plurality of electronic keys, a determining unit that determines driving possibility of a vehicle on which the in-vehicle device is mounted on the basis of the acquired key information, and a transmitting unit that transmits driving information indicating a driving situation in correlation with the key information if driving is determined as possible by the determining unit. The vehicle operation system further comprises a communication device that receives the driving information transmitted by the transmitting unit of the in-vehicle device from the in-vehicle device or through the electronic key in a communication manner, and the communication device includes a storage unit that stores the received driving information in correlation with vehicle identification information of the vehicle on which the in-vehicle device is mounted, and the key information output from the electronic key or driver identification information of a driver specified from the key information.

An in-vehicle device according to an embodiment, comprises: an acquiring unit that acquires key information from any one electronic key among a plurality of electronic keys; a determining unit that determines driving possibility of a vehicle on which the in-vehicle device is mounted on the basis of the acquired key information; and a transmitting unit that transmits driving information indicating a driving situation in the vehicle in correlation with the key information if driving is determined as possible by the determining unit.

A vehicle operation method according to an embodiment, is performed in a system that comprises a plurality of electronic keys, and an in-vehicle device that transmits and receives a signal to and from the plurality of electronic keys. The vehicle operation method includes: storing key information by each of the plurality of electronic keys; outputting the key information to the in-vehicle device by the electronic key; acquiring key information output from any one electronic key among the plurality of electronic keys by the in-vehicle device; determining driving possibility of a vehicle on which the in-vehicle device is mounted on the basis of the acquired key information by the in-vehicle device; transmitting driving information indicating a driving situation in correlation with the key information by the in-vehicle device if driving is determined as possible; receiving the driving information transmitted by a transmitting unit of the in-vehicle device from the in-vehicle device or through the electronic key in a communication manner by a communication device that exists outside the vehicle; and storing the received driving information in a storage unit in correlation with vehicle identification information of the vehicle on which the in-vehicle device is mounted, and the key information output from the electronic key or driver identification information of a driver specified from the key information.

Each of a plurality of electronic keys stores key information in advance. An output unit outputs the key information to an in-vehicle device. With regard to an output method, the key information may be transmitted through communication, or the key information may be output as characters, a voice, or a video, and the key information may be acquired by reading the characters, the voice, or the video on the in-vehicle device side.

The in-vehicle device acquires the key information output from any one electronic key among the plurality of electronic keys, determines driving possibility from the key information, and transmits driving information to a communication device if driving is determined as possible. The communication device receives the driving information transmitted to the communication device from the in-vehicle device directly or through the electronic key. Another communication device (communication medium) may be interposed in a reception route. However, compatibility between direct transmission from the in-vehicle device to the communication device, and transmission through the electronic key is possible, and thus the transmission aspects are not excluded.

The communication device stores driving information in correlation with identification information of a vehicle on which the in-vehicle device is mounted. The driving information may be stored in correlation with the key information or identification information of a driver of a vehicle which is specified from the key information. According to this, driving information indicating a driving situation is collected for every vehicle, or for every driver specified on the basis of the key information with which driving with respect to the vehicle is determined as possible. Examples of the driving information include a speed, acceleration applied to a vehicle body, weight, a video obtained by capturing the inside or outside of the vehicle, time information corresponding to each piece of information, and the like.

In the vehicle operation system according to an embodiment, the transmitting unit of the in-vehicle device transmits the driving information to the electronic key in correlation with the vehicle identification information. The electronic key includes a first communication unit that receives the driving information and the vehicle identification information which are transmitted from the in-vehicle device, and a second communication unit that transmits the driving information and the vehicle identification information with the key information to the communication device, the driving information and the vehicle identification information are received by the first communication unit. The communication device receives the driving information, the vehicle identification information, and the key information through the one electronic key, and stores the pieces of information in correlation with the key information or driver identification information specified from the key information.

An electronic key according to an embodiment, comprises: a storage unit that stores key information; an output unit that outputs the key information to an in-vehicle device; a first communication unit that receives driving information indicating a driving situation in a vehicle on which the in-vehicle device is mounted, and vehicle identification information from the in-vehicle device if driving is determined as possible by the in-vehicle device on the basis of the output key information; and a second communication unit that transmits the driving information and the vehicle identification information which are received by the first communication unit, to a communication device, with the key information stored in the storage unit.

Vehicle driving information that can be acquired by the in-vehicle device and indicates a driving situation is transmitted from the in-vehicle device to a communication device through an electronic key storing the key information with which driving is determined as possible. According to a configuration in which information is transmitted from an electronic key carried by a driver, the in-vehicle device may transmit the driving information to an electronic key that exists in a short range, and thus it is possible to reduce a communication load of the in-vehicle device. It is possible to transmit information to an external communication device by using an existing communication device of a communication terminal by using a communication terminal device such as a smartphone as the electronic key, and it is possible to improve communication efficiency.

Driving information indicating a driving situation is stored in correlation with key information that is stored in the electronic key and is used to determine driving possibility. With respect to each vehicle, it becomes easy to record operation representing that which driver drives the vehicle, when the vehicle is driven, and how to drive the vehicle while realizing efficient sharing of the vehicle due to the key information.

In the operation system according to an embodiment, the key information is transmitted in advance from the communication device to a part or all of the plurality of electronic keys, and a part or all of the electronic keys store the transmitted key information.

It is assumed that the key information stored in the electronic key is transmitted from the communication device in advance. Since the communication device that collects the driving information understands the key information in advance, even when the driving information is transmitted only in correlation with the key information, the communication device can know other pieces of relating information (driver identification information and vehicle identification information) already, and thus it is possible to efficiently collect information.

In the operation system according to an embodiment, the driving information includes position information of the vehicle.

The driving information includes position information indicating a position at each point of time during driving of the vehicle. According to this, a movement trajectory of the vehicle, that is, a moving line is collected.

The in-vehicle device may include a first position detection unit that uses a receiving unit configured to receive a radio wave from a beacon, and detects a position of the vehicle on the basis of beacon identification information included in a signal based on the radio wave received by the receiving unit, and radio wave reception intensity of the radio wave. As the position information, information based on a position detected by the first position detection unit may be used.

The in-vehicle device may include: an input unit that inputs a video signal transmitted from a camera device that captures the periphery of the vehicle; and a second position detection unit that detects a position of the vehicle on the basis of a corresponding relationship between label identification information and a position which is specified from an arrangement of colors of a color label if the color label colored with two or more colors in a specific positional relationship is captured in an image based on the video signal that is input by the input unit. As the position information, information based on a position detected by the second position detection unit may be used.

In the operation system according to an embodiment, the in-vehicle device includes an input unit that inputs a video signal transmitted from a camera device that captures the periphery of the vehicle, and the driving information includes the video signal during driving of the vehicle.

The driving information is a video signal obtained by capturing the periphery of a vehicle by a camera device to capture an object or a person near the vehicle at each point of time during driving. According to this, a video record during driving of the vehicle is collected.

Note that, the present application can be realized by an operation system including specific selection units, an in-vehicle device, electronic key and an operation method, and can be realized as a program that causes a computer to realize characteristic processes. In addition, the present application may be realized by a semiconductor integrated circuit that realizes a part or all of processes in the in-vehicle device or the electronic key, or may be realized by another system in which the operation system and another device exhibit functions in conjunction with each other.

### Advantageous Effects

According to the present disclosure, it is possible to efficiently collect a driving situation of a vehicle.

### Detailed Description of an Embodiment of the Present Invention

Hereinafter, a vehicle operation system according to the present disclosure will be described with the accompanying drawings illustrating an embodiment.

### First Embodiment

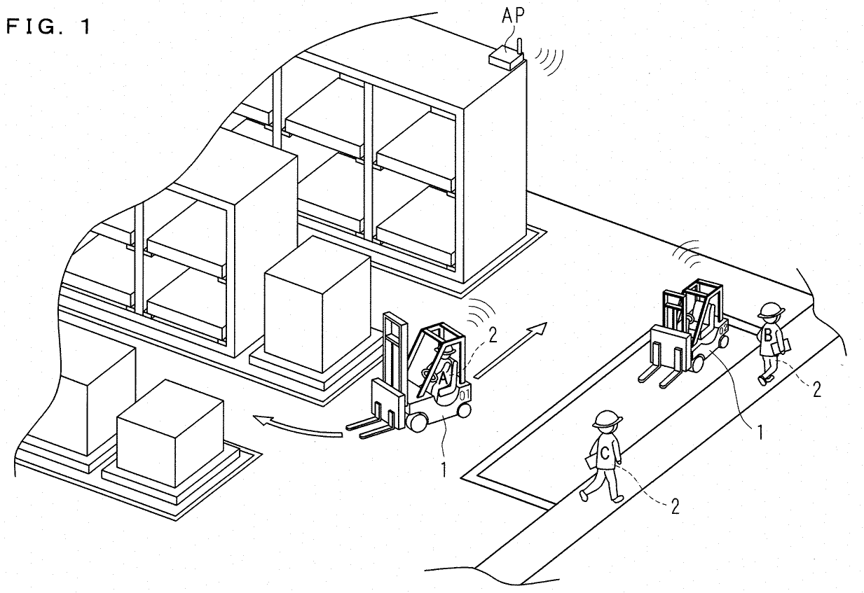

FIG. 1 is a view illustrating an overview of the vehicle operation system according to the first embodiment. In the vehicle operation system, an operation situation of a forklift 1 is transmitted to a communication device that exists inside or outside a factory while being distinguished by using information for identifying a forklift 1, and is intensively collected in the communication device. Examples of the operation situation include a location and a time at which an operating worker is identified, and loading or unloading is performed, information of movement trajectory (moving line), a detection result of collision or danger, and the like. It is possible to take a measure such as strengthening of safety management by analyzing driving tendency from a corresponding relationship between collision accidence in a work site, and vehicle information and driver identification information when danger before leading to accidence is detected on the basis of the operation situation that is collected in the communication device. In addition, when movement line data of the forklift 1 in a work site is also collected in the communication device as the operation situation and the movement line data is analyzed, it is possible to realize various applications such as the number of the forklift 1 to be disposed, a storage position and a storage amount of loads to be carried, and appropriate arrangement of the loads. In addition, when the communication device collects the operation situation in real time, it is also possible to transmit an instruction of operation content toward the forklift 1 from the communication device on the basis of the operation situation. According to this, it is possible to realize efficient use of the forklift 1 in correspondence with the situation of the work site at each point of time.

In the vehicle operation system of the present disclosure, collection of the operation situation as described above is realized by using an electronic key 2 for driving the forklift 1. When using a system of the electronic key 2 capable of transmitting and receiving a radio signal to and from the in-vehicle device 10, it is possible to collect the operation situation for every forklift 1 by distinguishing the operation situation on the basis of “which worker drives the forklift 1 in which manner”. When referring to FIG. 1, a worker A, a worker B, and a worker C carry the electronic key 2. Key identification information for individually identifying the electronic key 2 is stored in the electronic key 2. When storing worker identification information of a worker who carries a corresponding key in the communication device that collects information in the communication device in correspondence with the key identification information, it is possible to specify which worker carries which electronic key 2, and which forklift 1 is driven by the worker. For example, with regard to one forklift 1, it is possible to distinguish the worker B who has terminated work by using the forklift 1, and the worker C who will use the forklift 1 from now on the basis of the information stored in a plurality of the electronic keys 2 respectively carried by the workers. In the vehicle operation system of the present disclosure, a driving history indicating which worker performs which driving is collected in the communication device in correlation with key-side attribute information stored in each of the electronic keys 2, and utilization of the driving history can be expected.

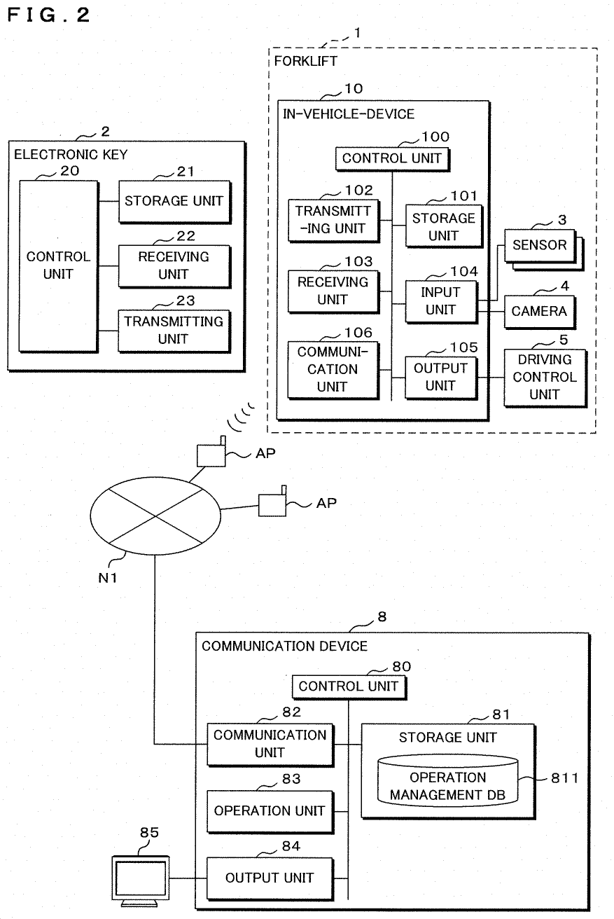

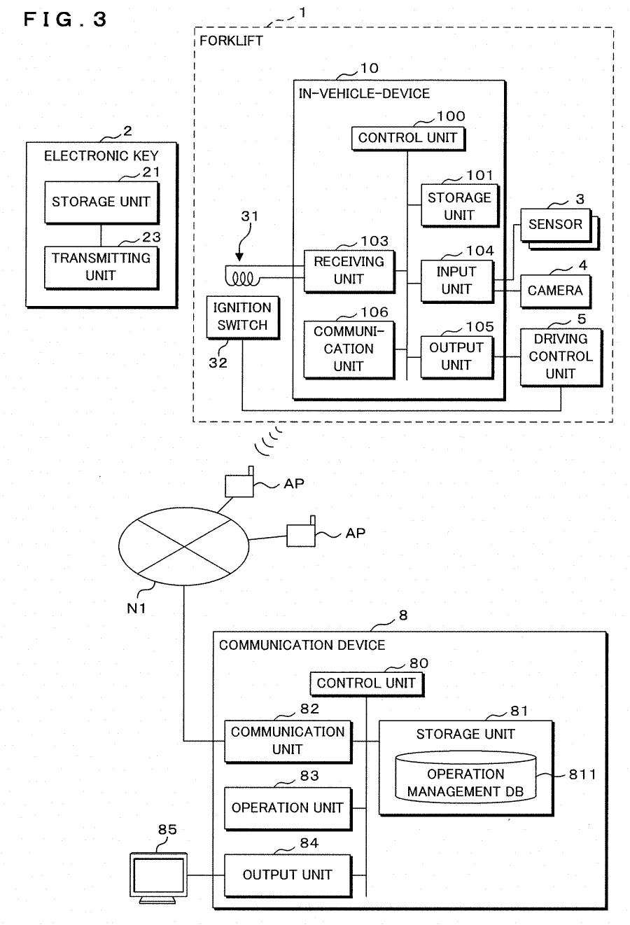

FIG. 2 and FIG. 3 are block diagrams illustrating a configuration of the vehicle operation system according to the first embodiment. The vehicle operation system includes the in-vehicle device 10 provided in the forklift 1, the electronic key 2, and a communication device 8. FIG. 2 illustrates a passive radio wave type in which an inquiry is made to the electronic key 2 from the in-vehicle device 10 side, and FIG. 3 illustrates an electromagnetic induction type in which a signal transmitted from the electronic key 2 inserted into a key cylinder is received on the in-vehicle device 10 side.

The in-vehicle device 10 includes a control unit 100, a storage unit 101, a transmitting unit 102, a receiving unit 103, an input unit 104, an output unit 105, and a communication unit 106. For example, the control unit 100 is a microcontroller that uses one or a plurality of central processing units (CPU) or a multi-core CPU, and includes a read only memory (ROM), a random access memory (RAM), an input/output interface, a timer, and the like. The control unit 100 is a determining unit that controls operations of respective constituent units by executing a control program stored in an embedded ROM, and executes makes a determination on driving possibility to be described later.

The storage unit 101 is a nonvolatile memory such as a flash memory and an electrically erasable programmable read-only memory (EEPROM). The storage unit 101 stores information (rewriting is possible) for determining possibility of driving by a driver who carries the electronic key 2, and vehicle identification information (rewriting is impossible) for identifying the forklifts 1. Note that, the storage unit 101 of the in-vehicle device 10 according to the first embodiment stores key identification information that specifically identifies the electronic key 2 as information (key information) for determining that driving is possible. For example, if one forklift 1 can be shared by three persons including the worker A, the worker B, and the worker C, all pieces of key identification information of the electronic keys 2 carried by the three persons are stored in the storage unit 101.

The transmitting unit 102 is a circuit that modulates a signal input from the control unit 100 by using a carrier wave, and transmits the resultant signal from a transmission antenna as a radio signal. The transmitting unit 102 uses a low frequency band (LF band) in a range of 30 kHz to 300 MHz or a very low frequency band (VLF band) in a range of 3 kHz to 30 kHz as a frequency band of the carrier wave. Note that, signal output power of the transmitting unit 102 is set to, for example, a range including a body of a worker who drives the forklift 1 on a driver's seat of the forklift 1 around a site of an antenna of the transmitting unit 102. That is, communication is possible only with the electronic key 2 carried by a driver who sits on a driver's seat.

The receiving unit 103 is a circuit that receives a signal of an ultra-high frequency band (UHF band, also referred to as “RF band”) in a range of 300 MHz to 3 GHz from an antenna, demodulates the signal, and outputs the signal to the control unit 100.

The input unit 104 is an interface that inputs a signal from the outside of the in-vehicle device 10. The control unit 100 can receive information from the outside from the input unit 104. A sensor 3 group and a camera 4 are connected to the input unit 104, and the control unit 100 can acquire information from the sensor 3 group and the camera 4 by the input unit 104.

The output unit 105 is an interface that outputs a signal indicating driving possibility to a driving control device 5. Note that, the output unit 105 may be a communication unit that is connected to an in-vehicle local area network (LAN), or may be a communication unit in combination with the input unit 104.

The communication unit 106 uses a radio communication device using Wi-Fi or the like, and can be connected to a network N1 inside a factory for communication through an access point AP provided at respective sites inside the factory. Note that, the access point AP may be provided at another location inside the factory, and the communication unit 106 may acquire information for identifying an access point that is connected for communication. Note that, the communication unit 106 may be directly connected to the communication device 8 for communication, and in this case, the communication unit 106 may use Bluetooth (registered trademark). A type of the communication unit 106 does not matter as long as communication between the control unit 100 and the communication device 8 is realized.

If signal exchange between the in-vehicle device 10 and the electronic key 2 is the electromagnetic induction type illustrated in FIG. 3, the in-vehicle device 10 does not include the transmitting unit 102 in comparison to the passive type illustrated in FIG. 2. In the electromagnetic induction type, the receiving unit 103 demodulates a signal read out with an antenna coil 31 provided in a key cylinder.

As the sensor 3, a plurality of various sensors such as a vehicle speed sensor that measures a vehicle speed, an acceleration sensor that detects impact to a vehicle body, a weight sensor that measures a weight applied to forks of the forklift 1, and an infrared sensor that measures a distance up to an adjacent object. The sensor 3 may be a reader that reads information stored in an RFID tag from the RFID tag provided in an object to be conveyed by the forks. The sensor 3 group is a general term of the sensors and the reader.

The camera 4 also functions as a camera for realizing recording with a video with respect to an operation of the forklift 1. The camera 4 includes a first camera capable of capturing a forward side at a front side of the forklift 1, a second camera capable of capturing a rearward side at a rear side, and a third camera that captures a worker who sits on a driver's seat or stands on the driver's seat. Only the first camera and the second camera may be provided. Note that, an angle of view of the first camera and the second camera may be set so that 360 degrees around the forklift 1 can be captured in conformity to the angle of view, and the first camera and the second camera may have sufficient dustproof and waterproof durability. Note that, an internal memory is provided in the camera 4, and video data based on a video signal is sequentially stored in the internal memory, and old data is sequentially overwritten.

The driving control device 5 is a device that controls driving by an engine or a drive motor of the forklift 1. The driving control device 5 starts the engine or the drive motor on the basis of a state of an ignition switch or the power-on switch, and a signal that is output from the in-vehicle device 10 and indicates driving possibility, and can perform automatic stoppage in correspondence with the state. The driving control device 5 in the case of the electromagnetic induction type illustrated in FIG. 3, the state of the ignition switch is detected at a position of the key in the key cylinder.

The electronic key 2 includes a control unit 20, a storage unit 21, a receiving unit 22, and a transmitting unit 23. For example, the control unit 20 is a microcontroller that uses one or a plurality of CPUs or a multi-core CPU, and includes a ROM, RAM, an input/output interface, a timer, and the like.

As the storage unit 21, a nonvolatile memory such as a flash memory and an EEPROM is used. Specific key identification information (rewriting is possible) for identifying each of a plurality of the electronic keys 2 is stored in the storage unit 21. In the first embodiment, the key identification information is used as information (key information) for determining driving possibility to be described later. As the key information, other pieces of information (identification information of a driver who carries a key and key information that is applied in advance) different from the key identification information may be stored.

As the receiving unit 22, a module including a reception antenna corresponding to the transmitting unit 102 of the in-vehicle device 10 and a demodulator is used. A frequency band that is used by the receiving unit 22 is an LF band or a VLF band. There is no limitation to the frequency band as long as correspondence with the transmitting unit 102 of the in-vehicle device 10 is established.

As the transmitting unit 23, a module that is connected to a transmission antenna for a frequency corresponding to the receiving unit 103 of the in-vehicle device 1 and includes a modulator that modulates a signal transmitted from the transmission antenna is used. A frequency band that is used by the transmitting unit 23 is the UHF band (RF band). There is no limitation to the frequency band as long as correspondence with the receiving unit 103 of the in-vehicle device 1 is established.

In a case of detecting reception of a request signal from the in-vehicle device 1, the control unit 20 of the electronic key 2, the key identification information stored in the storage unit 21 is transmitted from the transmitting unit 23 in a state of being included in a response signal. In addition, if the signal exchange between the in-vehicle device 10 and the electronic key 2 is the electromagnetic induction type illustrated in FIG. 3, the electronic key 2 does not include the control unit 20 and the receiving unit 22 in comparison to the passive type illustrated in FIG. 2. In the electromagnetic induction type, the transmitting unit 23 is a transponder coil, and when a key portion of the electronic key 2 is inserted into the key cylinder of a vehicle, key identification information or key information as another piece of information is read out from storage unit 21 on the in-vehicle device 1 side.

For example, the communication device 8 is a personal computer (PC) that is used by a user having authority of a manager in a work site. The communication device 8 includes a control unit 80, a storage unit 81, a communication unit 82, an operation unit 83, and an output unit 84, and the output unit is connected to a monitor 85.

The control unit 80 constitutes respective units by using a CPU. The control unit 80 executes a process procedure to be described later on the basis of a program that is stored in the storage unit 81, and operates as an operation management device.

The storage unit 81 uses a non-volatile storage device such as a flash memory and a hard disk. An operation management DB 811 is stored in the storage unit 81. The operation management DB 811 includes a work plan in a work site and a record of the work site. The operation management DB 811 includes worker identification information for identifying the workers A, B, and C who work at the work site, an organization identification information indicating an organization (a department, a part, a group, and the like) of the workers A, B, and C, vehicle identification information for identifying the forklift 1. In addition, the operation management DB 811 stores information transmitted from the in-vehicle device 10 of the forklift 1 as described later as an operation record. In addition, the operation management DB 811 of the storage unit 81 stores correspondence between key identification information of the electronic key 2 at the time of starting work on a day, and worker identification information of a worker who carries the electronic key 2 on the day.

The communication unit 82 can be connected to the network N1 inside a factory for communication in a wireless or wired manner. The control unit 80 can receive information transmitted from the in-vehicle device 10 by the communication unit 82 through the network N1 inside the factory.

The operation unit 83 is a user interface such as a mouse and a keyboard, and the control unit 80 executes a process in correspondence with an operation detected by the operation unit 83. The output unit 84 is an interface with the monitor 85, and the control unit 80 can output information stored in the storage unit 81 or information received by the communication unit 82 to the monitor 85 as an image.

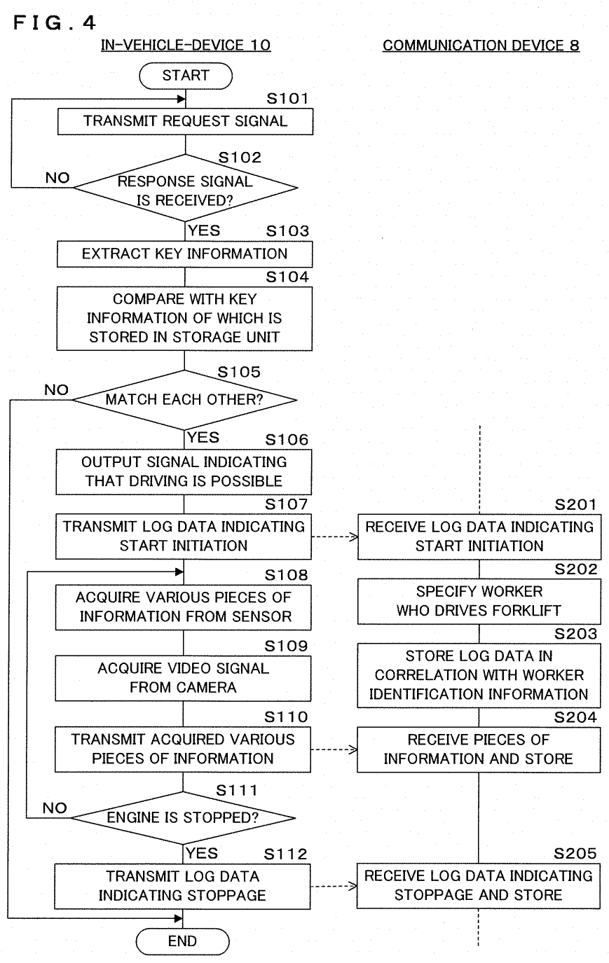

Description will be given of a process procedure relating to transmission and reception of information in a system configured as described above with reference to a flowchart. FIG. 4 is a flowchart illustrating an example of a process procedure of information transmission from the in-vehicle device 10 to the communication device 8 according to the first embodiment. In a state in which an engine (or a drive motor) of the forklift 1 is stopped, the control unit 100 of the in-vehicle device 10 executes the following process. Note that, the process procedure illustrated in the flowchart of FIG. 4 corresponds to a case where the passive radio wave type electronic key 2 is used.

The control unit 100 periodically transmits a request signal for confirming whether or not the electronic key 2 exists in an output range from the transmitting unit 102 (step S101). The control unit 100 determines whether or not the receiving unit 103 receives a response signal with respect to the request signal (step S102), and if it is determined that the response signal is not received (S102: NO), the process is returned to step S101.

In step S102, if it is determined that the response signal is received (S102: YES), the control unit 100 extracts key information (key identification information of the electronic key 2) included in the received response signal (step S103). If another piece of information for determining driving possibility is included in the response signal, in step S103, the control unit 100 may also extract the information.

The control unit 100 compares the key information extracted in step S103, that is, the key identification information of the electronic key 2, and key identification information, which is stored in the storage unit 101, of a target of which driving is determined as possible (step S104), and determines whether or not the extracted key identification information and the key identification information of the target of which driving is determined as possible match each other (step S105). In step S105, if it is determined that matching is not established (S105: NO), the control unit 100 terminates the process as is. Note that, at this time, if a user interface such as a display or a voice output unit with which a driver can make a confirmation is provided, the control unit 100 may output a message from the output unit 105 so that a message indicating non-permission of driving is displayed or a voice of the message is output from the user interface.

In step S105, if it is determined that matching is established (S105: YES), the control unit 100 outputs a signal indicating that driving is possible from the output unit 105 to the driving control device 5 (step S106). Then, the engine or the drive motor is started by the driving control device 5, and thus driving becomes possible.

First, the control unit 100 transmits log data indicating that driving is initiated to the communication device 8 in correlation with time information (time stamp) acquired by an embedded timer through the network N1 inside the factory (step S107). Note that, in step S107, vehicle identification information of the forklift 1 correlated with the log data and the key identification information extracted from the electronic key 2 are transmitted in correlation with each other.

Then, the control unit 100 acquires various pieces of information from the sensor 3 group in combination with time information (step S108). In step S108, for example, the control unit 100 acquires a speed of the forklift 1 at each point of time in combination with a time stamp (count value) obtained from the embedded timer. The acquired information may be the acceleration of the forklift 1, the weight applied to forks, or identification information of an object to be conveyed as described in description of the sensor 3.

The control unit 100 acquires a video signal from the camera 4 in combination with time information (step S109). In step S108, the control unit 100 may acquire the video signal output from the camera 4 in a state of being encoded to video data, or may acquire image data of an image that captures the video signal and may acquire a count value of the embedded timer at the time of the capturing.

The control unit 100 transmits the acquired various pieces of information from the sensor 3 group and the video signal from the camera 4 from the communication unit 106 to the communication device 8 in combination with time information acquired in combination with the video signal and the vehicle identification information of the forklift 1 through the network N1 inside the factory (step S110).

In addition, the control unit 100 determines whether or not the engine is stopped (step S111). In step S111, for example, the control unit 100 determines whether or not the power-on switch enters an off-state in the passive radio wave type, or whether or not the ignition switch enters an off-state in the electromagnetic induction type. If the forklift 1 is operated by the drive motor, the control unit 100 may determine whether or not the power switch enters an off-state.

In step S111, if it is determined that the engine is not stopped (S111: NO), the control unit 100 returns the process to step S108 after a predetermined waiting time, and continuously performs acquisition of various pieces of information during driving and transmission of the pieces of information to the communication device 8.

In step S111, if it is determined that the engine is stopped (S111: YES), the control unit 100 transmits log data indicating that driving is terminated to the communication device 8 in correlation with time information acquired by the embedded timer through the network N1 inside the factory (step S112), and terminates the process.

On the communication device 8 side, if the log data indicating that driving is initiated and the time information is transmitted from the in-vehicle device 10, the control unit 80 receives the log data and the time information by the communication unit 82 (step S201). The control unit 80 specifies a worker who drives the forklift 1 according to the log data on the basis of the key identification information transmitted in correlation with the log data (step S202).

In step S202, specifically, the control unit 80 specifies the worker as follows. As described above, the operation management DB 811 of the storage unit 81 stores correspondence between the key identification information of the electronic key 2 and the worker identification information of a worker who carries the electronic key 2 at the time of initiating work in a working time on the day. Accordingly, the control unit 80 can specify a worker who is a driver (extract the worker identification information) by the key identification information.

The control unit 80 stores the log data indicating driving initiation in the operation management DB 811 in correlation with the worker identification information of the specified worker (or the key identification information) and in correlation with the time information transmitted in combination, and the vehicle identification information (step S203).

In addition, similarly, if information sequentially transmitted from the sensor 3 during driving and information from the camera 4 are transmitted, the control unit 80 receives the pieces of information, and stores the pieces of information in combination with time information in the operation management DB 811 in correlation with the worker identification information and the vehicle identification information (step S204). Furthermore, if the log data indicating driving stoppage is transmitted from the in-vehicle device 10, the control unit 80 receives the log data by the communication unit 82, and stores the log data in combination with time information in the operation management DB 811 in correlation with the worker identification information and the vehicle identification information (step S205).

As described above, information from the sensor 3 group and the video information from the sensor 3 group, which indicate the operation situation by the forklift 1, are sequentially stored in correlation with not only the vehicle identification information for identifying the forklift 1 but also the worker identification information of a worker who is permitted to drive. As described above, with regard to one forklift 1, any worker can drive the forklift 1 if the worker carries a key corresponding to any one of a plurality of pieces of key identification information which are stored in the storage unit 101 of the forklift 1. According to this, it is possible to sequentially specify which worker carries which electronic key 2 and drives which forklift 1 in which manner, that is, an operation situation by the communication device 8 while realizing efficient sharing of the forklift 1 by the electronic key 2. Since the operation situation of the forklift 1 can be sequentially specified from the communication device 8, and thus it is possible to change the operation of the forklift 1 or work content of the worker in real time in correspondence with the situation. In addition, with respect to each forklift 1, it becomes easy to record operation representing that which driver drives the forklift 1, when the forklift 1 is driven, and how to drive the forklift 1 while realizing efficient sharing. It is possible to take a measure such as enhancement of safety management by analyzing driving tendency of each worker from the operation record correlated with vehicle identification information and the worker identification information.

### Second Embodiment

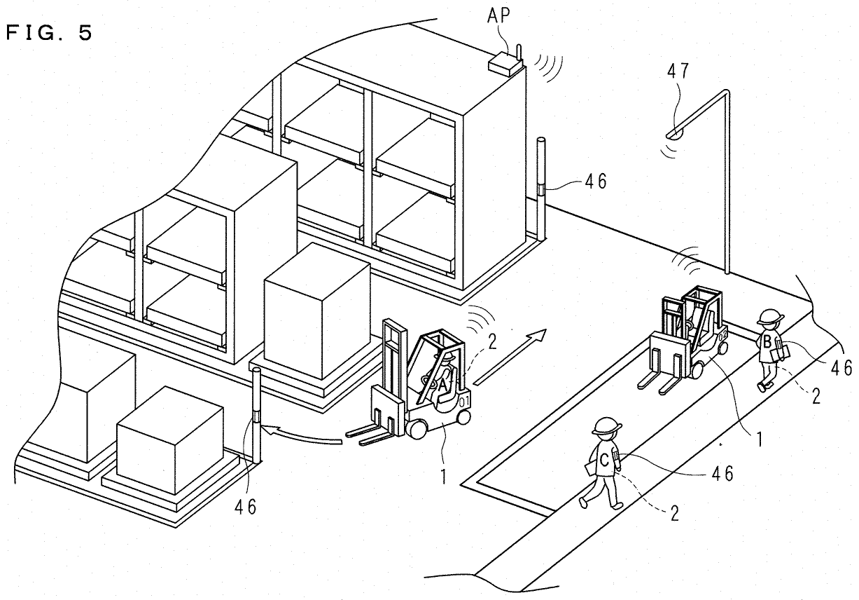

In a second embodiment, as information collected in the operation management DB 811 of the communication device 8, position information of the forklift 1 is added. FIG. 5 is a view illustrating an overview of a vehicle operation system according to the second embodiment. In the second embodiment, a bar, to which a color label 46 colored in a specific positional relationship with two or more colors is attached, stands at respective sites inside a factory, and an arm band including the color label 46 is mounted around an overarm of the workers A, B, and C. Furthermore, in the second embodiment, a beacon 47 that emits a radio wave stands at respective sites inside the factory. The in-vehicle device 10 of the forklift 1 can receive a radio wave from the beacon 47.

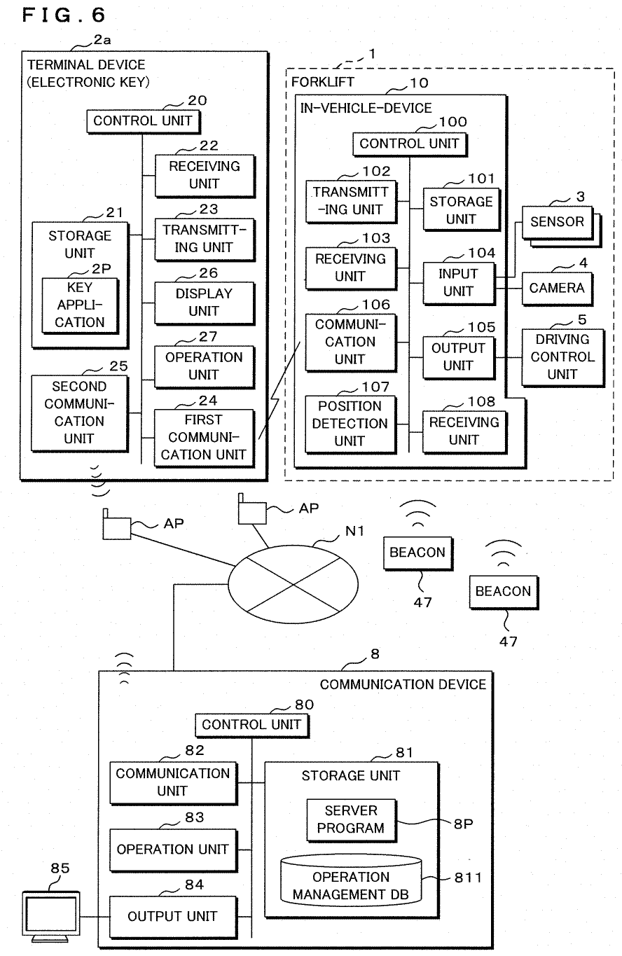

FIG. 6 is a block diagram illustrating a configuration of the vehicle operation system according to the second embodiment. In the vehicle operation system according to the second embodiment, the electronic key 2 is realized as one function of a terminal device 2a. In addition, the terminal device 2a performs communication with the communication device 8. The other configurations are the same as in the first embodiment, and the same reference numeral as in the first embodiment will be given to a common configuration, and detailed description thereof will be omitted. Furthermore, in FIG. 6 and in the following description, description will be given with reference to an example of a signal transmission and reception procedure by the passive radio wave type.

In the second embodiment, a communication unit 106 of the in-vehicle device 10 operates as a communication module that performs communication directly with the terminal device 2a. In this case, the communication unit 106 uses Bluetooth (registered trademark). The communication unit 106 may employ another standard as long as communication connection with the terminal device 2a is established by the communication module.

In addition, the in-vehicle device 10 according to the second embodiment includes a position detection unit 107. The position detection unit 107 detects a position from beacon identification information of the beacon 47 and information indicating a position of the beacon 47 which are stored in advance, and radio wave reception intensity by using a receiving unit 108 that is provided in the in-vehicle device 10 as a device configured to receive a radio wave from the beacon 47. The receiving unit 108 that receives a radio wave from the beacon 47 may also serve as the communication unit 106 and may receive the radio wave by using Bluetooth communication. In addition, the position detection unit 107 may specify label identification information of the color label 46 from an arrangement of colors captured in a captured image of the color label 46 captured with the camera 4, and may detect a position on the basis of a corresponding relationship between the label identification information and information indicating a position, and the size of the color label 46 in the captured image. Position detection by a radio wave receiving unit from the beacon 47 can be used in combination. Note that, the color label 46 is also included in the arm band of the workers as illustrated in FIG. 5. In a case of identifying capturing of the color label 46 included in the arm band of a worker from the label identification information of the color label 46, the position detection unit 107 detects the capturing when the forklift 1 is close to the worker. In addition, the position detection unit 107 may transmit the beacon identification information of the beacon 47, the radio wave reception intensity, the label identification information, or the captured image of the color label 46 to the communication device 8 to detect a position on the communication device 8 side.

The terminal device 2a is a so-called smart phone provided with antennas of an LF band and a UHF band. The terminal device 2a includes a control unit 20, a storage unit 21, a receiving unit 22, a transmitting unit 23, a first communication unit 24, a second communication unit 25, a display unit 26, and an operation unit 27.

The control unit 20 includes a CPU, a ROM, a clock, and the like. The control unit 20 causes the terminal device 2a that is a general-purpose computer to operate as a specific processing device that exhibits a function of the electronic key 2 to be described later on the basis of various programs including a key application (application program) 2P stored in the storage unit 21.

The storage unit 21 includes a nonvolatile memory such as a flash memory. The storage unit 21 stores various programs including the key application 2P and worker identification information (worker ID) for identifying a worker who carries the terminal device 2a in advance in correlation with the key application 2P. In the second embodiment, the worker identification information can be used as key information for determining driving possibility.

The receiving unit 22 and the transmitting unit 23 are similar to constituent units in the passive type electronic key 2 according to the first embodiment. A module including an antenna of the LF band to the VLF band and a demodulator that is connected to the antenna, and a module including an antenna of an UHF band and a modulator that is connected to the antenna are provided in a housing of the terminal device 2a that is a smart phone, and the modules can be controlled by the control unit 20.

The first communication unit 24 is a communication module that is connected to the communication unit 106 of the in-vehicle device 10 for communication, and uses, for example, Bluetooth (registered trademark). A communication module of another standard may be employed as long as correspondence with the communication unit 106 is established.

The second communication unit 25 is a radio communication device corresponding to Wi-Fi, and realizes communication connection to a network N1 inside a factory through an access point AP. Note that, the second communication unit 25 may exhibit a function as the first communication unit 24. For example, a Wi-Fi radio communication device may be commonly used as the first communication unit 24 and the second communication unit 25, and communication with the in-vehicle device 10 and communication connection to the network N1 inside the factory through the access point AP are realized.

The display unit 26 is a touch panel embedded display using a display such as a liquid crystal display and an organic electro luminescence (EL) display. The display unit 26 displays various pieces of information such as an acception button for an application based on the key application 2P on the basis of a process by the control unit 20.

The operation unit 27 is a touch panel that is embedded in the display unit 26 and a physical button that is provided in the housing of the device. In addition, the operation unit 27 may be a device (a keyboard or a pointing device) that accepts an operation input of a user.

In the terminal device 2a configured as described above, if a worker performs an operation of activating the key application 2P, the control unit 20 reads out and executes the key application 2P, and can exhibit a function as the electronic key 2 such as outputting of a signal that makes an instruction for key locking or key unlocking from the transmitting unit 23. In addition, in the second embodiment, it is assumed that worker identification information (worker ID) is stored in the storage unit 101 of the in-vehicle device 10 as key information with which driving is determined as possible. In the terminal device 2a, the terminal device 2a that activates the key application 2P responds to a request signal from the in-vehicle device 10, and if the worker identification information 210 stored in correlation with the key application 2P matches information 1C with which driving of the forklift 1 as a target is determined as possible, the terminal device 2a permits driving of the in-vehicle device 10.

In addition, in the communication device 8 according to the second embodiment, a server program 8P corresponding to the key application 2P (client program) in the terminal device 2a is stored in the storage unit 81.

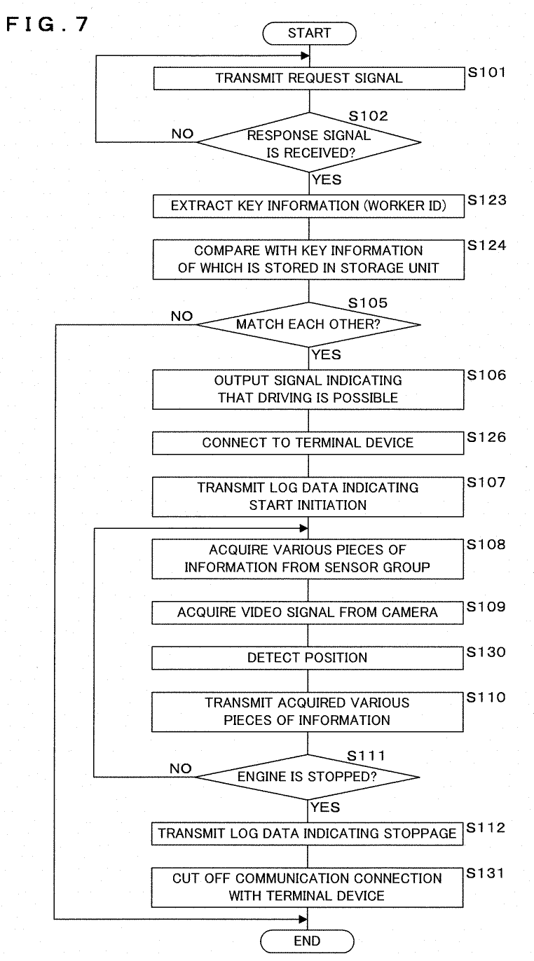

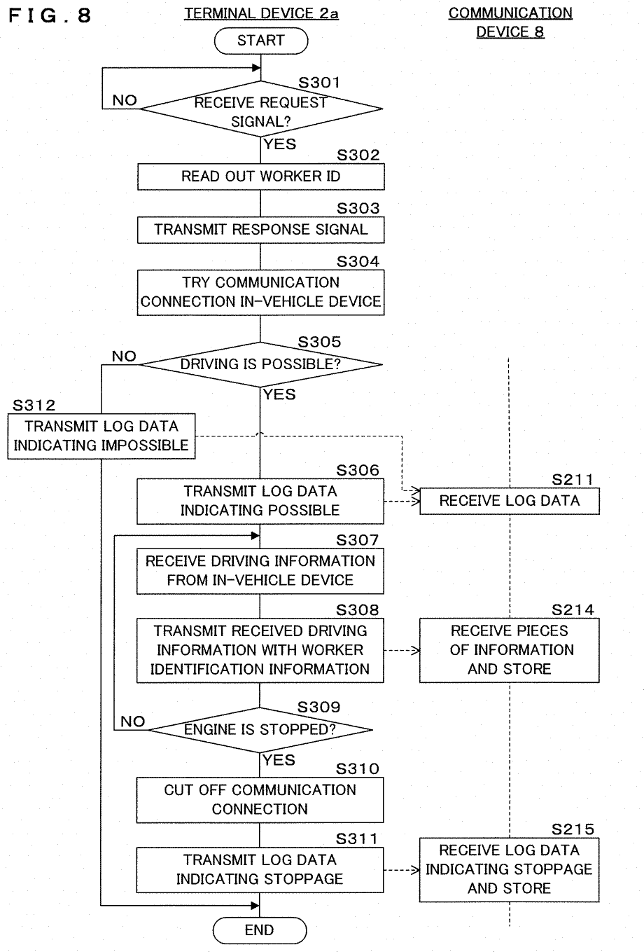

FIG. 7 and FIG. 8 are flowcharts illustrating an example of a process procedure of information transmission and reception between respective devices according to the second embodiment. FIG. 7 illustrates a process procedure on the in-vehicle device 10 side, and FIG. 8 illustrates a process procedure in the terminal device 2a and the communication device 8. The same step number will be given to a procedure common to the process procedure illustrated in the flowchart of FIG. 4 according to the first embodiment among process procedures on the in-vehicle device 10 side as illustrated in the flowchart of FIG. 7, and detailed description thereof will be omitted.

The control unit 100 of the in-vehicle device 10 transmits a request signal (S101), and if it is determined that a response signal for the request signal is received (S102: YES), the control unit 100 extracts worker identification information (worker ID) as key information included in the received response signal (step S123). In addition, if the key identification information is included, the key identification information may also be extracted. Note that, the request signal that is transmitted in step S102, connection information for communication connection (pairing) to the in-vehicle device 10 by the terminal device 2a may be included, and fixed connection information may be set to the in-vehicle device 10 in advance, and the connection information may be registered on the terminal device 2a side in advance.

The control unit 100 compares the worker identification information extracted in step S123 and the worker identification information, which is stored in the storage unit 101 in advance, of a target for which driving is determined as possible (step S124), and determines whether or not matching is established (S105). If it is determined that matching is established (S105: YES), the control unit 100 is connected to the terminal device 2a for communication by the communication unit 106 (step S126), and transmits a log indicating driving initiation toward the terminal device 2a with which communication connection is established (S107).

Then, the control unit 100 acquires information from the sensor 3 group of the in-vehicle device 10 (S108), and in a case of acquiring a video signal from the camera 4 (S109), a position is detected by the position detection unit 107 (step S130). As described above, the position detection in step S130 is realized by radio wave reception from the beacon 47, the color label 46 captured in an image captured by the video signal from the camera 4, or the like.

The control unit 100 according to the second embodiment transmits position information indicating the position detected in step S130 from the communication unit 106 to the network N1 inside the factory toward the communication device 8 as a destination in combination with time information acquired in combination with the position information, and the vehicle identification information of the forklift 1 in addition to acquired various pieces of information from the sensor 3 group and the video signal from the camera 4 (S110).

In addition, if it is determined in step S111 that an engine is stopped (S111: YES), the control unit 100 transmits log data indicating driving termination to the terminal device 2a with which communication connection is established in correlation with time information acquired by the embedded timer (step S112). Then, the control unit 100 cuts off communication connection with the terminal device 2a (step S131) and terminates the process.

Description will be given of communication between the terminal device 2a and the communication device 8 with reference to the flowchart of FIG. 8. The control unit 20 of the terminal device 2a that operates as the electronic key 2 determines whether or not a request signal from the in-vehicle device 10 is received (step S301). In step S301, if it is determined that the request signal is not received (S301: NO), the control unit 20 returns the process to step S301. If it is determined the request signal is received (S301: YES), the control unit 20 reads out the worker identification information stored in the storage unit 21 (step S302). The control unit 20 transmits a response signal including the read-out worker identification information as key information from the transmitting unit 23 to the in-vehicle device 10 (step S303).

The control unit 20 of the terminal device 2a tries communication connection with the in-vehicle device 10 by the first communication unit 24 (step S304), and determines driving possibility in accordance with possibility or impossibility of connection (step S305). Determination of driving possibility in step S305 may be made in accordance with whether or not communication connection is possible and information indicating log data indicating driving initiation is received.

If it is determined that driving is possible (S305: YES), the control unit 20 transmits log data indicating that driving is possible from the second communication unit 25 to the communication device 8 (step S306). Then, the control unit 20 of the terminal device 2a sequentially receives driving information including information from the sensor 3 and information transmitted from the camera 4 which are transmitted in combination with time information, and position information from the in-vehicle device 10 during driving by the first communication unit 24 with which communication is established (step S307). The control unit 20 transmits the received driving information in combination with the time information from the second communication unit 25 to the communication device 8 in correlation with the worker identification information and the vehicle identification information (step S308). With regard to transmission timing in step S308, the transmission may be performed whenever information from the in-vehicle device 10 is received, or information from the in-vehicle device 10 may be stored in the storage unit 21 at once and the information may be periodically read out and transmitted.

The control unit 20 determines whether or not an engine (or a drive motor) of the forklift 1 is stopped (step S309), and if log data indicating driving termination is not received and it is determined that the engine is not stopped (S309: NO), the control unit 20 returns the process to step S307 to continuously receive information.

If it is determined that the engine is stopped (S309: YES), the control unit 20 cut off the communication connection with the in-vehicle device 10 by invalidating the first communication unit 24 or the like (step S310), transmits log data indicating driving stoppage to the communication device 8 from the second communication unit 25 (step S311), and terminates the process.

Note that, in step S305, if it is determined that driving is impossible (S305: NO), that is, if communication connection is not established, the control unit 20 transmits log data indicating driving impossibility from the second communication unit 25 to the communication device 8 (step S312), and terminates the process. At this time, the control unit 20 may output a message indicating driving non-permission to be displayed within a screen of the key application 2P in the display unit 26.

On the communication device 8 side, if log data indicating driving initiation and time information are transmitted from the terminal device 2a, the control unit 80 receives the log data and the time information by the communication unit 82, and stores the log data and the time information in the operation management DB 811 in correlation with the worker identification information (worker ID) and the vehicle identification information which are transmitted in correlation (step S211). If received log data is log data indicating driving impossibility, the control unit 80 stores the log data and terminates the process.

Whenever the driving information is transmitted from the terminal device 2a, the control unit 80 receives the driving information in correlation with time information, the worker identification information, and the vehicle identification information, and stores the pieces of information in the operation management DB 811 (step S214).

In addition, if log data indicating driving stoppage is transmitted from the terminal device 2a, the control unit 80 receives the log data by the communication unit 82, and stores the log data in combination with time information in the operation management DB 811 in correlation with the worker identification information and the vehicle identification information (step S215).

As described above, since the position information detected by the beacon 47 provided in respective sites inside the factory or the color label 46 is also collected in combination in the communication device 8 as driving information of the forklift 1, it is possible to store various pieces of information relating to the operation of the forklift 1 in the operation management DB 811. Collection of position information can be analyzed as data of a movement trajectory, that is, a moving line relating to each forklift 1 for every driver, and thus it is also possible to present an efficient moving line for every driver. In addition, it is possible to realize various applications such as the number of the forklift 1 to be disposed for every factory, and appropriate arrangement of a storage position and a storage amount of loads to be carried.

In addition, when the driving information is transmitted from the in-vehicle device 10 to the communication device 8 that collects information through the terminal device 2a, it is possible to easily perform collection in correlation with information from the terminal device 2a capable of storing a driver's attribute (worker identification information, a driving function, or a work plan). In addition, it is possible to effectively utilize various sensors and communication modules which are generally provided in the terminal device 2a. In the electronic key 2 that is not the terminal device 2a, a specific storage process is necessary to store individual information of a worker who carries the terminal device 2a in the electronic key 2. It is necessary to store correspondence between the key identification information and a worker as a user on the communication device 8 side. In contrast, in the terminal device 2a, it is easy to store information of a worker who carries the terminal device 2a, and driving information of the forklift 1 that is driven and the driving information are transmitted to the communication device 8 in correlation with each other and are stored in the operation management DB 811. According to this, correlation between the worker identification information and the driving information is easily accomplished. In addition, for example, even when the same terminal device 2a is used by another worker, if a plurality of pieces of worker identification information are correlated with the key application 2P, and the key application 2P is activated after selecting a worker who uses the terminal device 2a, it becomes easy to correlate the driving information and the identification information of a worker as a driver by using individual information of the worker as key information.

In addition, the in-vehicle device 10 may detect danger of collision with a walking pedestrian, another forklift 1, or a facility or the like inside the factory which is approaching a worker through capturing of the color label 46 or by an acceleration sensor that is one of the sensor 3. Content of driving information is changed between a case where danger is detected, and the other case, and the content (presence or absence of a video, or the like) may be transmitted.

### Third Embodiment

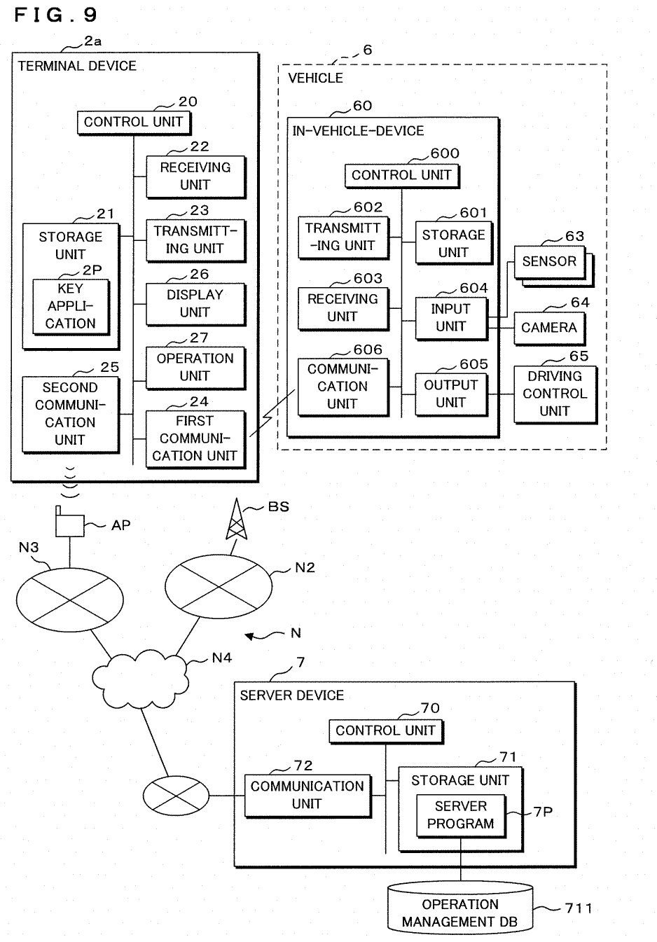

In a third embodiment, a target of the operation management is not limited to the forklift 1. In the third embodiment, description will be given of a vehicle operation system as a system that realizes lease management of various vehicles including the forklift 1. FIG. 9 is a block diagram illustrating a configuration of the vehicle operation system according to the third embodiment. The vehicle operation system according to the third embodiment includes an in-vehicle device 60 of a vehicle 6, an electronic key 2 (terminal device 2a) that is a smart phone carried by a driver, and a server device 7 that is managed by a dealer who is an owner of the vehicle 6 and leases the vehicle 6 to the driver. In the third embodiment, the in-vehicle device 60 determines driving possibility on the basis of key information transmitted from the electronic key 2. The key information has a time limit, and is transmitted to the in-vehicle device 60 from the server device 7 through a network N and is stored in the in-vehicle device 60. That is, the key information is a ticket that is issued by the server device 7. Driving of the vehicle 6 is possible due to the ticket. In addition, it is possible to collect a driving history for every driver in which drivers are distinguished in the server device 7 from the in-vehicle device 10 in correlation with the key information.

The same reference numeral as in the first embodiment or the second embodiment will be given to a configuration common to the first embodiment or the second embodiment among configurations described in the third embodiment, and detailed description thereof will be omitted.

The in-vehicle device 60, a sensor 63 group, a camera 64, and a driving control device 65 are mounted on the vehicle 6 according to the third embodiment. The in-vehicle device 60 includes a control unit 600, a storage unit 601, a transmitting unit 602, a receiving unit 603, an input unit 604, an output unit 605, and a communication unit 606. Note that, in the third embodiment, different reference numerals are given to the constituent units so as not to limit the vehicle 6 to the forklift 1, but the constituent units are the same as in the in-vehicle device 10 described in the first embodiment. Accordingly, reference numerals of which 60th and 600th units correspond to the reference numerals of the in-vehicle device 10, the sensor 3 group, the camera 4, and the driving control device 5 described in the first embodiment will be given to constituent units of the third embodiment, and detailed description thereof will be omitted.

Note that, a communication unit 606 of the in-vehicle device 60 according to the third embodiment is a radio communication device corresponding to Wi-Fi and the like, and is a communication device capable of establishing communication connection to a public network N3 through an access point AP. Communication connection with the server device 7 through a public network N4 can be established by a predetermined safe route. The communication unit 606 also includes a communication module capable of establishing communication through a base station BS of a carrier network N2 provided by a communication service provider, and may have a configuration in which communication connection with the server device 7 through the carrier network N2 with a public network N4 interposed therebetween.

In addition, the camera 64 mounted on the vehicle 6 also functions as a drive recorder. The camera 64 includes a first camera capable of capturing a forward side at a front side of the vehicle 6, a second camera capable of capturing a rearward side at a rear side, and a third camera that captures a driver who sits on a driver's seat. Only the first camera and the second camera may be provided.

The control unit 600 of the in-vehicle device 60 can execute a process of inputting a video signal that is output from the camera 64 through an input unit 604, and capturing a video by using a part of the storage unit 601 as a buffer.

As in the configuration according to the second embodiment, in a second communication unit 25 provided in the terminal device 2a that functions as the electronic key 2, communication connection to the public network N3, to which the access point AP is connected, can be established through the access point AP. In addition, in a control unit 20, communication connection with the server device 7 from the public network N3 through the public network N4 can be established by a predetermined safe route through the second communication unit 25. In addition, the second communication unit 25 can be connected to the carrier network N2 provided the communication service provider by the base station BS, and can establish communication connection with the server device 7 through the carrier network N2 and the public network N4.

A network N is a communication route including the public network N3 and the access point AP connected to the public network N3, the carrier network N2 and the base station BS, and the public network N4.

The server device 7 is a server computer that is managed by a lease dealer (rental dealer). The server device 7 includes a control unit 70, a storage unit 71, and a communication unit 72. The control unit 70 constitutes respective units by using a CPU. The control unit 70 executes a process on the basis of a server program 7P stored in the storage unit 71 in correspondence with the key application 2P of the terminal device 2a, and operates as a lease ticket issuing device.

The storage unit 71 uses a nonvolatile storage device such as a hard disk. In addition to the server program 7P, an operation management DB 711 of the vehicle 6 is stored in the storage unit 71. The operation management DB 711 includes an operation history (driver identification information or a movement trajectory) for every piece of vehicle identification information of the vehicle 6, or the like.

The communication unit 72 is a communication module that is connected to the public network N4 for communication through a network device for safe connection in a wired or wireless manner. The control unit 70 can transmit and receive information to and from the terminal device 2a or the in-vehicle device 10 by the communication unit 72 through the public network N4.

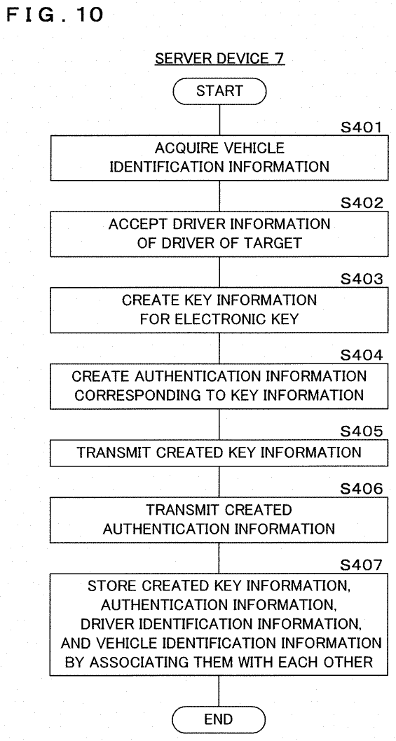

In the vehicle operation system configured as described above, first, the server device 7 issues the key information with which driving is determined as possible in a limited period. For example, it is assumed that the lease dealer leases one vehicle 6 for about two weeks in an arbitrary period. A manager of the lease dealer takes a step for issuing the key information relating to the one vehicle 6 and information (authentication information) for permitting driving by the key information to the in-vehicle device 60 side from a manager web page provided by the server program 7P of the server device 7. FIG. 10 is a flowchart illustrating an example of key information issuing process procedure in the server device 7.

The control unit 70 of the server device 7 acquires vehicle identification information of the vehicle 6 that is a lease target during the issuing step (step S401). Driver information of a driver of the leaser target is accepted (step S402). The driver information includes license information of a driver who will drive the vehicle 6, driver identification information (user ID), presence or absence of an option corresponding to a lease plan content, and the like. It is considered that presence or absence of the option represents limitation of performance (a movement range or a usable function) in the vehicle 6 in correspondence with the content of driver information.

The control unit 70 creates key information with which driving is determined as possible with respect to the vehicle 6 that is the lease target on the basis of the accepted driver information (step S403). For example, it is assumed that the key information the driver identification information (user ID), a lease target period, and information relating to presence or absence of the option are encoded on the basis of a time-limited encryption key. Note that, in the third embodiment, the key information is set as a two-dimensional bar code to be decoded after being captured with the camera 64.

In addition, the control unit 70 creates information (authentication information) which corresponds to the key information created in step S403 and with which driving is determined as possible in a case of the created key information on the in-vehicle device 60 side (step S404). For example, the authentication information created in step S404 is driver identification information, and information of the encryption key.

Next, the control unit 70 transmits the created key information to the electronic key 2 (terminal device 2a) corresponding to the driver identification information (step S405). In step S405, for example, when the terminal device 2a that activates the key application 2P by using the driver identification information accesses a user web page provided by the server device 7 and acquires a driver page, the key information is included in the page, and thus the terminal device 2a can acquire the key information. Note that, an application for a lease may be transmitted to the terminal device 2a with an electronic mail that is stored in correspondence with the driver identification information.

The control unit 70 transmits the authentication information created in step S404 to the in-vehicle device 60 (step S406), stores the created key information, authentication information corresponding to the key information, corresponding driver identification information, and vehicle identification information of the lease target in the storage unit 71 in correlation with each other (step S407), and terminates the process.

As described above, the authentication information is stored in the storage unit 601 of the in-vehicle device 60 by the process steps as described above. Note that, in the third embodiment, the authentication information that is stored in the storage unit 601 in a time-limited manner corresponds to only one driver (or drivers of the same group). In the in-vehicle device 60, when receiving the transmitted authentication information from the communication unit 606, the control unit 600 stores the authentication information in the storage unit 601, and automatically deletes the authentication information when the lease period transmitted in combination has elapsed.

In the terminal device 2a, when a driver activates the key application 2P in correlation with the identification information applied to the driver, the control unit 20 receives (acquires) the key information transmitted in step S405 by the second communication unit 25, and stores the received key information in the storage unit 21.

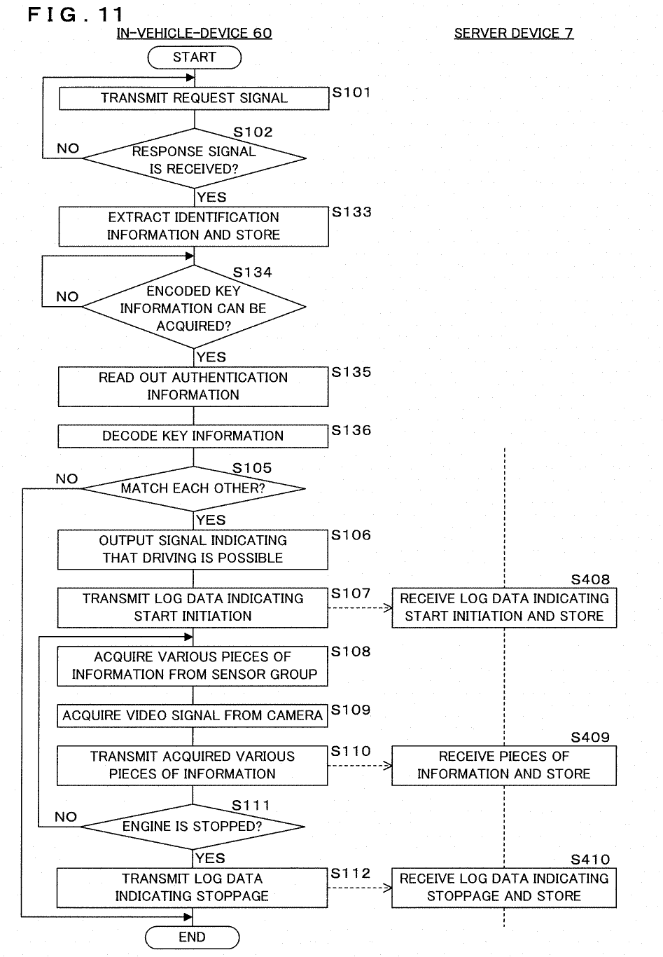

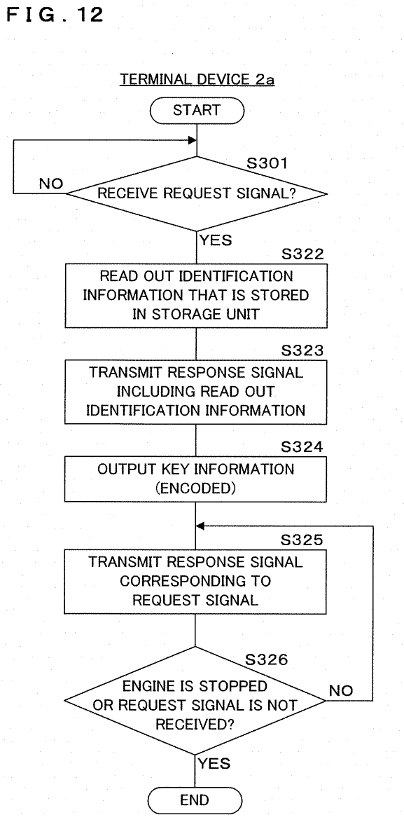

As described above, in a state in which the key information and the authentication information which respectively correspond to the terminal device 2a (electronic key 2) and the in-vehicle device 60 are stored, when the following process procedure is executed, driving information indicating a driving situation is collected in the operation management DB 711 of the server device 7 in correlation with information relating to driving possibility. FIG. 11 and FIG. 12 is a flowchart illustrating an example of a process procedure of determination on driving possibility of the vehicle 6 and driving information collection according to the third embodiment. FIG. 11 illustrates a process procedure in the in-vehicle device 60 and the server device 7, and FIG. 12 illustrates a process procedure in the terminal device 2a. Note that, the same step number will be given to a procedure, which is common to the procedure in the in-vehicle device 10 as illustrated in the flowchart of FIG. 4 according to the first embodiment among procedures illustrated in the flowchart of FIG. 11, and detailed description thereof will be omitted.

The control unit 600 of the in-vehicle device 60 according to the third embodiment transmits a request signal (S101), and if it is determined that a response signal is received (S102: YES), the control unit 600 extracts device-specific identification information of the electronic key 2 (terminal device 2a) which is included in the response signal, and temporarily stores the identification information in an embedded memory or the storage unit 601 (step S133).

Next, the control unit 600 determines whether or not the encoded key information output from the terminal device 2a can be acquired (step S134). In step S134, for example, the control unit 600 executes capturing of a video signal of the third camera which is input from the camera 64, and determines whether or not key information can be acquired from a two-dimensional bar code. The key information is output in a character line, and thus the control unit 600 may determine whether or not the key information can be acquired through character recognition from an image that is captured. In addition, if the key information is output as a voice or characters, the control unit 600 may determine whether or not input of the voice or the characters has been performed. Input may be ten-key (numerical key) input or microphone input through the input unit 604.

In step S134, if it is determined that acquisition is not performed (S134: NO), the control unit 600 returns the process to step S134, and waits until acquisition can be performed. If it is determined that acquisition can be performed (S134: YES), the control unit 600 reads out authentication information that is transmitted from the server device 7 and is stored in the storage unit 601 in advance (step S135). In addition, the control unit 600 decodes the authentication information by using a time-limited encryption key included in the authentication information (step S136). The control unit 600 compares driver identification information included in the key information obtained through decoding in step S136, and driver identification information included in the authentication information read out in step S135, and determines whether or not matching is established (step S105). If it is determined that matching is established (S105: YES), the control unit 600 outputs a signal indicating that driving is possible to the driving control device 65 (S106), and transmits log data of starting initiation from the communication unit 606 to the server device 7 in combination with time information (S107).

Note that, the in-vehicle device 60 continuously performs acquisition of various pieces of information during driving and transmission of the acquired information to the server device 7 as driving information before it is determined in step S111 that the engine is stopped. When transmitting the driving information to the server device 7, the control unit 600 transmits any one of the decoded key information, the identification information of the terminal device 2a which is extracted from the response signal, and the vehicle identification information from the communication unit 606 to the server device 7 in correlation with the driving information. Since the server device 7 issues the key information, and thus the server device 7 can specify information for identifying the terminal device 2a and the vehicle 6 on the basis of any one of the pieces of information. Furthermore, the control unit 600 may periodically transmit a request signal that makes a request for a response signal including the device-specific identification information of the terminal device 2a to the terminal device 2a, and may confirm whether or not it is possible to continue communication with the terminal device 2a with which driving is determined as possible in a radio wave output range of the transmitting unit 602 and the receiving unit 603.

In the server device 7, when the log data indicating driving initiation and the time information are transmitted from the in-vehicle device 60, the control unit 70 receives the log data and the time information by the communication unit 72, and stores the log data and the time information in the operation management DB 711 (step S408). The log data may be correlated with the key information, the identification information of the terminal device 2a which is extracted from the response signal, and the vehicle identification information, or any one of the pieces of information, or may be stored as is.

In addition, similarly, if information from the sensor 63 and information from the camera 64 which are sequentially transmitted during driving are transmitted, the control unit 70 receives the pieces of information, and stores the pieces of information in the operation management DB 711 as driving information in combination with the time information, the key information, and the like (step S409). Furthermore, if log data indicating driving stoppage is transmitted from the in-vehicle device 60, the control unit 70 receives the log data by the communication unit 72, and stores the log data in combination with time information in the operation management DB 711 in combination in correlation with the key information, the identification information of the terminal device 2a, and the vehicle identification information, or any one of the pieces of information (step S410).

In the terminal device 2a according to the third embodiment, the control unit 20 determines whether or not a request signal from the in-vehicle device 60 is received (S301), and if it is determined in step S301 that the request signal is not received (S301: NO), the control unit 20 returns the process to step S301. If it is determined that the request signal is received (S301: YES), the control unit 20 reads out identification information that is stored in the storage unit 21 and is specific to the terminal device 2a (step S322). The control unit 20 transmits the response signal including the read-out identification information from the transmitting unit 23 to the terminal device 2a (step S323). In the third embodiment, as described in the process on the in-vehicle device 60 side, the information included in the response signal is not handles as key information.

When a response is made for the request signal, the control unit 20 of the terminal device 2a according to the third embodiment outputs the key information that is received from the server device 7 and is stored in the storage unit 21 in advance (step S324). In step S324, if the key information is a simple character line, the control unit 20 may cause display unit 26 to display the key information as characters, or may output the key information as a voice from a speaker. In addition, if the key information is an image such as a two-dimensional bar code, the control unit 20 causes the display unit 26 to display the key information.

Then, if driving of the vehicle 6 is permitted by the output key information, whenever receiving a request signal that is periodically transmitted to confirm existence within a predetermined range from an antenna of the in-vehicle device 60, the control unit 20 transmits a response signal including the identification information that is read out in step S322 (step S325). The control unit 20 determines whether or not a signal indicating stoppage is received, or a request signal is not received by the receiving unit 22 for a predetermined period or longer (step S326), and if any one is determined as YES (S326: YES), the control unit 20 terminates the process. If all are determined as NO (S326: NO), the control unit 20 returns the process to step S325, and continues the process.

As described above, log data (information obtained by the sensor 63 or the camera 64) of driving information is continuously transmitted from the communication unit 606 of the in-vehicle device 60 to the server device 7 during driving, and is stored in the operation management DB 711. Note that, the terminal device 2a side and the in-vehicle device 60 may be connected (paired) for communication by near field radio communication, and log data may be continuously transmitted from the terminal device 2a (as in the second embodiment). With regard to a driving situation of the vehicle 6, for example, when accessing a page that is provided by the server program 7P and a web server program (not illustrated) from a browser program that is standardly provided in the terminal device 2a used by the manager of the leaser dealer, the driving situation can be viewed from the page in real time or afterwards.

Note that, in the third embodiment, the electronic key 2 is realized as one function of the terminal device 2a, but output of the key information to the in-vehicle device 60 may be independent between the electronic key 2 and the terminal device 2a. That is, the vehicle operation system includes the electronic key 2, a smart phone which is not provided with the receiving unit 22 and the transmitting unit 23 and in which the key application 2P is stored, the in-vehicle device 60, and the server device 7. Both the identification information of the electronic key 2 which is given to a driver, and the driver identification information (user ID) are included in the authentication information that is created on the server device 7 side in advance with respect to the in-vehicle device 60. In addition, in this case, the in-vehicle device 60 may be set to determine that driving is possible only if the identification information of the electronic key 2 and the driver identification information included in key information that can be decoded from a two-dimensional bar code or the like which is output from the smart phone match identification information and driver identification information which are included in the authentication information.

As described above, since the server device 7 that receives driving information of the vehicle 6 and stores the driving information as a history issues the key information in advance, correlation between the electronic key 2, the driver identification information, and vehicle identification driving of the vehicle 6 that is driven is understood on the server device 7 side already at a point of issuing time. Accordingly, even though the driving information transmitted during driving is transmitted in a state of being correlated with only the key information, other pieces of related information (the driver identification information, the vehicle identification information, and the like) can be specified from the key information. That is, it is not necessary to sequentially transmit a plurality of pieces information in a state of being correlated with the driving information. As described above, it is possible to effectively collect information by using the key information.

As illustrated in the first to third embodiments, in the operation system of the present disclosure, various pieces of information (time information, a speed, acceleration, position information, a video signal, and the like) obtained by various kinds of the sensors 3 (63) and the camera 4 (64) which are provided in the forklift 1 (vehicle 6) are transmitted from the in-vehicle device 10 (60) to the server device 7 (communication device 8) in correlation with the key information for determining driving possibility. The various pieces of information may be transmitted from the in-vehicle device 10 (60) to the server device 7 (communication device 8) through the electronic key 2 (terminal device 2a). In addition, as illustrated in the third embodiment, the key information is issued in advance from the server device 7 (communication device 8) to the electronic key 2 (terminal device 2a) and the in-vehicle device 10 (60). As described above, information is transmitted and received between three devices including the server device 7 (communication device 8) of the manager, the electronic key 2 (terminal device 2a) carried by a driver, and the vehicle 6 (forklift 1) that is a driving target, and thus it is possible to collect information in a state of correlation of which driver drives which vehicle.

In the first to third embodiments, collection of driving possibility and driving information in the forklift 1 or the vehicle 6 has been described with reference to one vehicle, but it is also possible to collect driving information in parallel by performing the same process with respect to a plurality of vehicles.

It should be understood that all configurations of the disclosed embodiments are illustrative only, and are not limited. The scope of the invention is indicated by the following appended claims rather than the description, and all modifications in meaning and a range which are equivalent to the claims are included.

### DESCRIPTION OF REFERENCE NUMERALS

1 forklift (vehicle)
10, 60 in-vehicle device
100, 600 control unit
101, 601 storage unit
102, 602 transmitting unit
103, 603 receiving unit
104, 604 Input unit
105, 605 output unit
106, 606 communication unit
107 position detection unit
2 electronic key
2a terminal device (electronic key)
20 control unit
21 storage unit
22 receiving unit
23 transmitting unit
24 first communication unit
25 second communication unit
26 display unit
27 operation unit
2P key application
31 antenna coil
32 ignition (IG) switch
3 sensor
4 camera
46 color label
47 beacon
5 driving control device
6 vehicle
63 sensor
64 camera
65 driving control device
7 server device
70 control unit
71 storage unit
7P server program
72 communication unit
711 operation management DB
8 communication device
80 control unit
81 storage unit
811 operation management DB
8P server program
82 communication unit
83 operation unit
84 output unit
85 monitor
N1 network inside factory
N2 carrier network
N3 public network
N4 public network
N network
AP access point
BS base station

What is claimed is:

1-10. (canceled)

11. A vehicle operation system comprising:
a plurality of electronic keys;
an in-vehicle device that transmits and receives a signal to and from the plurality of electronic keys; and
a communication device,
wherein each of the plurality of electronic keys
stores key information, and
includes an output unit that outputs the key information to the in-vehicle device,
the in-vehicle device includes
an acquiring unit that acquires key information from any one electronic key among the plurality of electronic keys,
a determining unit that determines driving possibility of a vehicle on which the in-vehicle device is mounted on the basis of the acquired key information, and
a transmitting unit that transmits driving information indicating a driving situation in correlation with the key information if driving is determined as possible by the determining unit, and
the communication device includes
a communication unit that receives the driving information transmitted by the transmitting unit of the in-vehicle device from the in-vehicle device or through the electronic key, and
a storage unit that stores the received driving information in correlation with vehicle identification information of the vehicle on which the in-vehicle device is mounted, and the key information output from the electronic key or driver identification information of a driver specified from the key information.

12. The vehicle operation system according to claim 11, wherein
the transmitting unit of the in-vehicle device transmits the driving information to the electronic key in correlation with the vehicle identification information,
the electronic key includes
a first communication unit that receives the driving information and the vehicle identification information which are transmitted from the in-vehicle device, and
a second communication unit that transmits the driving information and the vehicle identification information with the key information to the communication device, the driving information and the vehicle identification information are received by the first communication unit, and
the communication device receives the driving information, the vehicle identification information, and the key information through the one electronic key, and stores the pieces of information in correlation with the key information or driver identification information specified from the key information.

13. The vehicle operation system according to claim 11, wherein
the key information is transmitted in advance from the communication device to a part or all of the plurality of electronic keys, and
the part or all of the electronic keys store the transmitted key information.

14. The vehicle operation system according to claim 11, wherein
the driving information includes position information of the vehicles.

15. The vehicle operation system according to claim 11, wherein
the in-vehicle device includes an input unit that inputs a video signal transmitted from a camera device that captures the periphery of the vehicle, and
the driving information includes the video signal during driving of the vehicle.

16. The vehicle operation system according to claim 14,
wherein the in-vehicle device includes
a first position detection unit that uses a receiving unit configured to receive a radio wave from a beacon, and detects a position of the vehicle on the basis of beacon identification information included in a signal based on the radio wave received by the receiving unit, and radio wave reception intensity of the radio wave.

17. The vehicle operation system according to claim 14, wherein
the in-vehicle device includes
an input unit that inputs a video signal transmitted from a camera device that captures the periphery of the vehicle, and
a second position detection unit that detects a position of the vehicle on the basis of a corresponding relationship between label identification information and a position which is specified from an arrangement of colors of a color label if the color label colored with two or more colors in a specific positional relationship is captured in an image based on the video signal that is input by the input unit.

18. An in-vehicle device, comprising:
an acquiring unit that acquires key information from any one electronic key among a plurality of electronic keys;
a determining unit that determines driving possibility of a vehicle on which the in-vehicle device is mounted on the basis of the acquired key information; and
a transmitting unit that transmits driving information indicating a driving situation in the vehicle in correlation with the key information if driving is determined as possible by the determining unit.

19. An electronic key, comprising:
a storage unit that stores key information;
an output unit that outputs the key information to an in-vehicle device;
a first communication unit that receives driving information indicating a driving situation in a vehicle on which the in-vehicle device is mounted, and vehicle identification information from the in-vehicle device if driving is determined as possible by the in-vehicle device on the basis of the output key information; and
a second communication unit that transmits the driving information and the vehicle identification information which are received by the first communication unit to a communication device with the key information stored in the storage unit.

20. A vehicle operation method, being performed in a vehicle operation system including a plurality of electronic keys, and an in-vehicle device that transmits and receives a signal to and from the plurality of electronic keys, the vehicle operation method comprising:
storing key information by each of the plurality of electronic keys;
outputting the key information to the in-vehicle device by the electronic key;
acquiring key information output from any one electronic key among the plurality of electronic keys by the in-vehicle device;
determining driving possibility of a vehicle on which the in-vehicle device is mounted on the basis of the acquired key information by the in-vehicle device;
transmitting driving information indicating a driving situation in correlation with the key information by the in-vehicle device if driving is determined as possible;
receiving the driving information transmitted by a transmitting unit of the in-vehicle device from the in-vehicle device or through the electronic key in a communication manner by a communication device that exists outside the vehicle; and
storing the received driving information in a storage unit in correlation with vehicle identification information of the vehicle on which the in-vehicle device is mounted, and the key information output from the electronic key or driver identification information of a driver specified from the key information.
